(19) United States
(12) Patent Application Publication
(10) Pub. No.: US 2007/0186589 A1
(43) Pub. Date: Aug. 16, 2007

(54) Mold for press-molding glass elements

(75) Inventor: James Cheng-Yuan Lung, Taipei City (TW)

Correspondence Address: BRUCE H. TROXELL, SUITE 1404, 5205 LEESBURG PIKE, FALLS CHURCH, VA, 22041, US

(73) Assignee: Ether Precision, Inc.

(21) Appl. No.: 11/350,797

(22) Filed: Feb. 10, 2006

(51) Int. Cl. C03B 9/48; C03B 11/08

(52) U.S. Cl. 65/374.12; 65/374.13

(57) ABSTRACT

A mold for press-molding glass elements is disclosed, which comprises a substrate and a protective film; wherein the protective film, being arranged on the substrate, is made of Mo-M alloy instead of those precious metal alloys such as platinum-iridium (Pt—Ir) alloy, iridium-rhenium (Ir—Re) alloy and iridium-ruthenium (Ir—Ru) alloy, etc., wherein M is Re, Hf, Zr, Tc or Os, being used as the protective film of prior-art molds. According, the mold of the invention can be manufactured at a comparatively lower cost while is capable of being used for press-molding glass elements of high precision and high softening point.

### FIELD OF THE INVENTION

The present invention relates to a mold for press-molding glass elements, and more particularly, to a mold having a protective film made of a Molybdenum (Mo)-M alloy, wherein M is Rhenium (Re), Hafnium (Hf), Zirconium (Zr), Technetium (Tc) or Osmium (Os), capable of being used for manufacturing glass elements of high precision and high softening point.

### BACKGROUND OF THE INVENTION

The earliest molding method for manufacturing fine glass lenses was first disclosed in the U.S. Pat. No. 3,833,347, entitled “METHOD FOR MOLDING GLASS LENSES”, by Eastman Kodak Company at 1974. During the period of more than twenty years' research and development after the first disclosure while following the development and application of new materials being used as the mold for press-molding glass elements and the matured of new processes utilizing the same, the period can be roughly divided into several generations characterizing by the materials used for making the mold and the protective films disposed on the mold, that is, as the use of amorphous carbon, silicon carbide (SiC), silicon nitride (Si₃N₄), hard ceramic section, metal, and precious metal as well as the application of all sorts of protective film, such as diamond like carbon (DLC) and boride ceramics.

There are several characteristics considered as important factors in the mold for press-molding glass elements, which are (1) the material of the mold does not react on the glass at a high temperature, i.e. the glass does not adhere to the mold surface; (2) the press surface of the mold is hard enough not to be damaged by a scratch or the like; (3) the mold is strong and stable enough that it is not to deform or break at a high temperature; (4) the mold is superior in resistance to heat shock; (5). The mold can be processed to form an optical surface with a comparably low cost and less processing time; and (6) the durability of the mold is improved to last for a comparably longer time so that the overall production cost of glass elements can be reduced.

The conventional mold for press-molding glass elements at least is consisted of a substrate and a protective film disposed thereon, or can be a structure consisting of a substrate, a buffer layer and a protective film. Wherein, the material suitable for making the substrate includes stainless steel, silicon carbide (SiC), tungsten carbide (WC) and so on, while the buffer layer is used for improving the adhesion of the material used for making the mold, or for enabling the mold to be sintered or processed more easily. Moreover, the protective film can be made of amorphous carbon, hard ceramics such as silicon carbide and silicon nitride, etc., or can be a film made of precious metals such as Pt—Ir alloys, Ir-containing alloys, Ru-containg alloys, etc., or can be a film made of Ir—Re alloys or Ir—Ru alloys, doped with a ceramic such as chromium nitride (CrN), tantalum nitride (TaN), aluminum oxide and the like. The techniques of using the aforesaid materials to form a mold are disclosed respectively in U.S. Pat. No. 5,538,528, TW Pat. No. 345535, 427957, 445242, 457219 and 506946. For instance, the Pt—Ir alloy disclosed in the TW Pat. No. 427957 can withstand a press-molding process of 570° C. for more than 2000 times; and the Ir—Re alloys or Ir—Ru alloys, doped with a ceramic such as chromium nitride (CrN), tantalum nitride (TaN), aluminum oxide and the like, is capable of withstand a press-molding process of 640° C. for more than 3000 times, or a press-molding process of 700° C. for more than 2000 times.

Since all the prior-art molds comprises a protective film made of a specific precious metal, which is being plated on the mold by sputtering, the overall cost of manufacturing those conventional molds can be very high and thus has adverse affect on its competitiveness.

### SUMMARY OF THE INVENTION

In view of the disadvantages of prior art, the primary object of the present invention is to provide a mold for press-molding glass elements, comprising a substrate having a layer of Mo-M alloy formed on a surface thereof as protective film by sputtering, wherein M is Re, Hf, Zr, Tc or Os, such that the mold of the invention can be manufactured at a comparatively lower cost while is capable of being used for press-molding glass elements of high precision and high softening point.

To achieve the above object, the present invention provides a mold for press-molding glass elements, comprising: a substrate; and a protective film made of a Mo-M alloy, wherein M is Re, Hf, Zr, Tc or Os, being arranged on the substrate while having a surface defining with specific molding patterns to press-mold glass.

In a preferred aspect, the substrate is made of tungsten carbide (WC).

In a preferred aspect, the molybdenum content of the Mo-M alloy is 35% to 70%.

In a preferred aspect, the protective film has a thickness of 0.5 μm to 1.0 μm.

In a preferred aspect, a buffer layer is arranged between the substrate and the protective film.

In a preferred aspect, the buffer layer is made of Nickel (Ni), Chromium (Cr), or Titanium (Ti).

In a preferred aspect, the buffer layer has a thickness of 0.1 μm to 0.2 μm.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a cross-sectional view of a mold for press-molding glass elements according to a first preferred embodiment of the invention.

FIG. 2 is a schematic view is a cross-sectional view of a mold for press-molding glass elements according to a second preferred embodiment of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

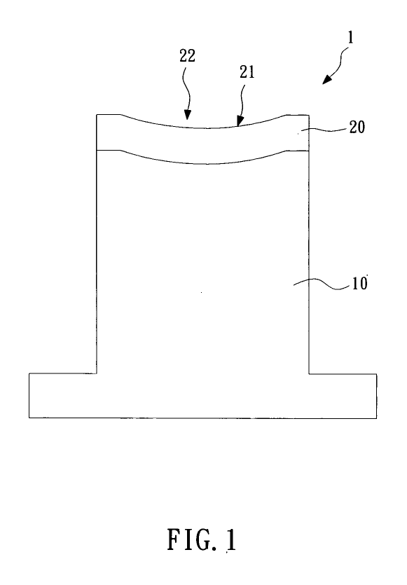

Please refer to FIG. 1, which is a cross-sectional view of a mold for press-molding glass elements according to a first preferred embodiment of the invention. As seen in FIG. 1, a mold 1 is consisted of a substrate 10 and a protective film 20 disposed on the substrate 10.

It is noted that the process for manufacturing the mold 1 comprises the steps of:
polishing a surface of the substrate 10, the substrate being made of WC-containing alloy; and
forming a protective film 20 made of a Mo-M alloy on the substrate 10 by sputtering while enabling the protective film 20 to have a surface 21 defined with specific molding patterns 22 to press-mold glass, wherein M is Re, Hf, Zr, Tc or Os, and the protective film has a thickness of 0.5 μm to 1.0 μm.

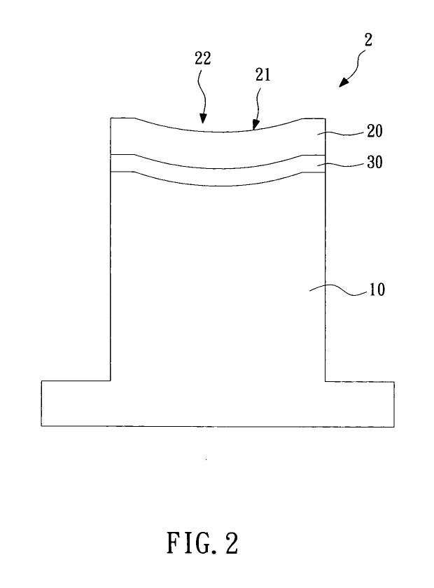

Please refer to FIG. 2, which is a schematic view is a cross-sectional view of a mold for press-molding glass elements according to a second preferred embodiment of the invention. The numbering and the elements shown in FIG. 2 is the same as those shown in FIG. 1 and thus are not described further hereinafter. The only difference between the mold 1 of the first embodiment shown in FIG. 1 and the mold 2 of the second embodiment shown in FIG. 2 is that the mold of FIG. 1 has an additional buffer layer 30, sandwiched between the substrate 10 and the protective layer 20.

Therefore, the process for manufacturing the mold 2 comprises the steps of:
polishing a surface of the substrate 10, the substrate being made of WC-containing alloy;
forming a buffer layer 30 made of nickel, chromium or titanium on the polished surface of the substrate 10 by sputtering, wherein the buffer layer 30 has a thickness of 0.1 μm to 0.2 μm; and
forming a protective film 20 made of a Mo-M alloy on the buffer layer 30 by sputtering while enabling the protective film 20 to have a surface 21 defined with specific molding patterns 22 to press-mold glass, wherein M is Re, Hf, Zr, Tc or Os, and the protective film has a thickness of 0.5 μm to 1.0 μm.

By varying the percentage of contents and the thickness of the protective film 20 formed on either the mold 1 of the first embodiment or the mold 2 of the second embodiment, a plurality of mold with protective film of different content percentage and thickness are produced and used as samples to be tested respectively in a high-temperature press-molding process. During each repeat of a high-temperature press-molding process, the L-BAL42 or L-LAL13 glass produced by OHARA Corp. is being placed on one of the plural molds to be press-molding in a nitrogen atmosphere for 120 seconds and then being left to cool while observing the condition of the protective film 20 of the tested mold periodically so as to check whether or not the protective film 20 is being vaporized or peeled off, wherein the extend of vaporization is judged by the measurement of surface roughness. A film with surface roughness under 110 Å is in good condition while a film with surface roughness over 110 Å is determined as damaged. Any kinds of peeling can be determined as damaged. In addition, the mold having a protective films 20 that can withstand at least 300 repeat of the high-temperature press-molding process without being damaged is marked by “OK”, otherwise, is marked by “not preferred”.

Table 1 is the test result of the plural molds according to the first embodiment of the present invention.

TABLE 1

| | protective film | | | buffer layer | | test condition | |
|---|---|---|---|---|---|---|---|
| | content percentage | | thickness | | thickness | | press-molding |
| | Mo | Hf | μm | content | μm | 600° C. | judgment |
| NO. 1 | 38 | 62 | 0.8 | Ni | 0.18 | >500 times | OK |
| NO. 2 | 38 | 62 | 0.5 | Ni | 0.17 | >600 times | OK |
| NO. 3 | 35 | 65 | 0.53 | Ni | 0.2 | >500 times | OK |
| NO. 4 | 55 | 45 | 0.6 | Ni | 0.2 | >500 times | OK |
| NO. 5 | 67 | 33 | 0.65 | Ni | 0.2 | >500 times | OK |
| NO. 6 | 70 | 30 | 0.6 | Ni | 0.2 | >500 times | OK |

And, Table 2 is the test result of the plural molds according to the second embodiment of the present invention.

TABLE 2

| | protective film | | | buffer layer | | test condition | |
|---|---|---|---|---|---|---|---|
| | content percentage | | thickness | | thickness | | press-molding |
| | Mo | Re | μm | content | μm | 600° C. | judgment |
| NO. 1 | 60 | 40 | 0.6 | Ni | 0.15 | >400 times | OK |
| NO. 2 | 50 | 50 | 0.5 | Ni | 0.13 | >300 times | OK |
| NO. 3 | 70 | 30 | 0.7 | Ni | 0.15 | >300 times | OK |
| NO. 4 | 35 | 65 | 0.6 | Ni | 0.15 | >300 times | OK |
| NO. 5 | 35 | 65 | 0.65 | Ni | 0.2 | >300 times | OK |

Each sampling of the press-molded glass at each repeat can not be exactly the same, the surface roughness of the tested protective films maintains under 110 Å without obvious vaporization.

From the aforesaid tables, it is noted that although the cost of the mold with protective film made of Mo-M (M is Re, Hf, Zr, Tc or Os) alloy is only 20% of a conventional mold covering with protective film made of prior-art precious metals, it still can withstand 300 times of press-molding at 580˜600° C. while maintaining its surface roughness under 110 Å with corresponding optical quality.

Therefore, the mold of the invention can be manufactured at a comparatively lower cost while is capable of being used for press-molding glass elements of high precision and high softening point.

While the preferred embodiment of the invention has been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A mold for press-molding glass elements, comprising:
a substrate; and
a protective film made of a Mo-M alloy, being arranged on the substrate, wherein M is Re, Hf, Zr, Tc or Os.

2. The mold of claim 1, wherein the substrate is made of tungsten carbide.

3. The mold of claim 1, wherein the molybdenum content of the Mo-M alloy is 35% to 70%.

4. The mold of claim 1, wherein the protective film has a thickness of 0.5 μm to 1.0 μm.

5. The mold of claim 1, further comprising a buffer layer, sandwiched between the substrate and the protective film

6. The mold of claim 5, wherein the buffer layer is made of Nickel, Chromium or Titanium.

7. The mold of claim 5, wherein the buffer layer has a thickness of 0.1 μm to 0.2 μm.
